(19) United States
(12) Patent Application Publication
(10) Pub. No.: US 2021/0062477 A1
(43) Pub. Date: Mar. 4, 2021

(54) Water recycle system

(71) Applicant: Qiusheng Gao, Cupertino, CA (US)

(72) Inventor: Qiusheng Gao, cupertino, CA (US)

(21) Appl. No.: 16/558,316

(22) Filed: Sep. 3, 2019

(51) Int. Cl. E03B 1/04; C02F 1/50; C02F 1/00; E03C 1/122

(52) U.S. Cl. CPC E03B 1/041; C02F 1/50; C02F 1/003; C02F 2103/002; E03B 2001/045; C02F 2307/14; E03C 1/1222

(57) ABSTRACT

Water shortage is a serious problem all over the world. Everyday people use toilet many times and waste lots of water. Some toilet water tank uses half tank of water to flush the pee, but toilet still uses lots of water. In some area without water supply, restroom is very dirty without flush water. This invention can solve those problems with very low cost.

Currently, sewage water is discarded after people take shower, wash hands, clothes or food. If the discarded sewage water is collected, filtered and purified, it can be used as toilet flush water. The key factor for this invention is that the water for flushing the toilet does not require high purified quality, so the cost of filtration and purification is very low. This invention could save 30%-60% of the water used in daily life. For the existing building, this invention requires minor modification to separate the water pipes for toilet flush from other usage on both supply and discharge.

This invention also provides a cheap solution for the movable restroom or restroom without water supply pipe system. With two water tanks, one for water supply and one for sewage water collection, the toilet can be flushed with the discharged sewage water after simple filtration and purification with the initial water filling in the water tank.

### TECHNICAL FIELD

The present invention generally relates to the water recycle system that flush the toilet using the sewage water after filtration and purification. The key factor for this invention is that the water for flushing the toilet does not require high purified quality, so the cost of filtration and purification is very low.

### BACKGROUND ART

Water shortage is a serious problem all over the world. Currently, most sewage water is discarded after people flush the toilet, take shower, wash hands, clothes or food. Everyday people use toilet many times and waste lots of water. In some area without water supply, restroom is very dirty without flush water. This invention can solve those problems with low cost. In places where water shortage is serious, this invention can save lots of water fee.

### SUMMARY OF THE INVENTION

An object of the present invention is to utilize the sewage water or recycle the toilet flush water for toilet flushing after certain ways of filtration and purification. To utilize the sewage water, the current water supply system needs to be modified in that the supply toilet flushing water is separated from the water for other usage and the discarded toilet flushing water is also separated from the other sewage water.

In accordance with the present invention, the sewage water is collected in a tank. The sewage water is filtered with some filtration equipment and purified with some chemical material. The clean water is pumped to the water tank specific for toilet flushing only. The pump powered by electricity is controlled by two water level controller switches, one in dirty water tank and one in clean water tank. If both tanks don't have enough water, the clean water tank will be supplemented with the regular clean water form the water supply pipe, controlled by a electric magnetic valve.

In accordance with the present invention, the discarded toilet flush water is collected in a water tank. The sewage water is filtered with some filtration equipment and purified with some chemical material. The processed water is pumped to the water tank for toilet flushing. The pump powered by the electricity is controlled by two water level controller switches, one in sewage water tank and one in processed water tank.

In accordance with the present invention, the water after filtering and purification can be pumped by manual air pump to the processed water tank. In such a situation, a sealed tank with one-way water valve is needed. When a person pushes the manual air pump, it will increase the pressure inside the tank, close the one-way valve and push the water to the processed water tank.

In accordance with the present invention, this water recycle system can be installed in almost any type of building that has toilets and water supply pipe system, movable restroom, restroom without water and power supply. The size of the tank depends on the number of people using toilets.

Many variations of design can be derived from this invention. For instance, the tank in the drawings is a cube, but it can be changed as a ball or columnar body. The position or shape of some components also can be changed.

### BRIEF DESCRIPTION OF THE DRAWINGS

There are four figures in the attached drawings.

FIG. 1 provides the vertical cross section view of the water recycle system using an electricity powered pump.

FIG. 2 provides the 3-D view of the tank that collects the sewage water, filter and purify the water.

FIG. 3 provides the vertical cross section view of the water recycle system using a manual air pump.

FIG. 4 provides the 3-D view of the sealed tank that delivers the processed water to the upper level tank by a manual air pump.

Following are the detailed information about the primary components of the equipment.
1. Water tank that collects sewage water, filter and purify the water.
2. First layer of filter.
3. Second layer of filter. There could be more layer of filters if necessary.
4. A pipe that carries in the sewage water to the water tank.
5. A pipe that delivers the clean water to the upper level water tank.
6. A water overflow pipe.
7. The area for garbage sediment.
8. The area for water purification.
9. The area for clean water.
10. A cover of the water tank.
11. Sewage water from sewage pipe.
12. A water level controller switch. When the water level goes up nearing the top of the water tank, the switch starts the pump. When the water level goes down nearing the bottom of the water tank, the switch stops the pump.
13. Clean water flow direction in the pipe.
14. The electricity powered pump.
15. A pipe that delivers the clean water to the upper level water tank.
16. Clean water flow direction.
17. Upper level water tank for clean water.
18. Water level controller switch in upper level water tank. When water level goes up nearing the top of water tank, the switch stops pump.
19. A water overflow pipe in upper level water tank.
20. The sealed water tank working with the manual air pump.
21. An air pipe that delivers the air to the water tank from the manual air pump.
22. A manual air pump that can be operated by hands.
23. A one-way water valve. The water after purification can flow to the sealed water tank through the valve. The valve is closed when the manual air pump pushes air to the water tank.
24. A floating ball.
25. A wheel that carries a wire that control the water level indicator.
26. A wire that controls the water level indicator.
27. Water level indicator.
28. Water level scale.
29. A stand that supports the floating ball.
30. A cover for the sealed water tank.
31. A manual air pump operated by foot.
32. A water pipe that delivers the water after filtration and purification to the toilet water tank.
33. Chemical material that purify the sewage water.
34. A pipe that delivers the chemical material to the water tank.
35. A pipe that supplements regular clean water when both water tanks don't have enough water.
36. Water valve that controls the water supplement. It can be a manual valve or an electric magnetic valve.

### DETAILED DESCRIPTION OF PREFERRED EMBODIMENTS

This water recycle system can be installed in almost all buildings with minor modification for the existing water pipes, separating the supply and discharge water pipe for toilet flush from other daily living water supply pipes and sewers.

When the sewage water (11) from the sewers of daily living water or toilet flush water comes into the water tank (1), the garbage will be sedimented and deposited in area (7). The sewage water (11) is filtered by filtration layer (2). The filtered water flows to area (8) and purified by chemical materials (33) that comes to the water tank area (8) through pipe (34). The purified water is filtered by the second filtration layer (3). There could be more purification area and filtration layer, depending on the required quality of the clean water. Finally, the purified water flows to area (9).

If the pump (14) is powered by electricity, the pump (14) will deliver the processed water from water tank area (9) through pipe (5) to the upper level water tank (17) through pipe (15). When the water level goes up nearing the top of the water tank (1), the water level controller switch (12) will start the pump (14). When the water level goes down nearing the bottom of the water tank (1), the water level controller switch (12) will stop the pump (14). When the water level goes up nearing the top of water tank (17), the water level controller switch (18) will also stop the pump (14). When both tanks (1) (17) don't have enough water, the water valve (36) will be opened to supplement regular clean water through pipe (35). If the water valve (36) is an electric magnetic valve, it is controlled by water level controller switch (12) (18).

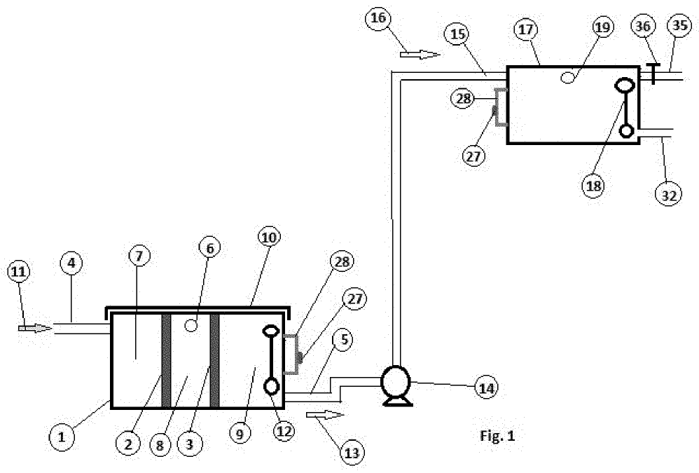

If the pump (22) (31) is operated by hands or foot, a sealed water tank (20) is used. The purified water will flow to the sealed water tank (20) through one-way water valve (23). The manual air pump (22) (31) will push air to the sealed water tank (20) through pipe (21). The increased pressure in the water tank (20) will close the one-way water valve (23) and push the clean water to the upper level water tank (17) through pipe (5) (15). There are many ways to display the water level in upper level water tank (17). FIG. 1 shows a floating ball (24) that controls the water level indicator (27). When the floating ball (24) goes up, the wire (26) passing through the wheel (25) pulls up the indicator (27) in the water level scale (28). When floating ball (24) goes down, the wire (26) passing through the wheel (25) releases the indicator (27) that goes down by its own weight. The person who operates the manual air pump (22) (31) can decide whether to start or stop pumping the water based on the water level indicator (27). The manual air pump is extremely useful for movable restroom or restroom without power and water supply. After one of the water tanks is filled once, it can be used for long time.

The processed water tank (17) will deliver the processed water to the toilet water tanks through pipe (32). Thus, the toilet flush water can use the recycled water from discharged toilet flush water or used living water. If the toilet flush water uses the recycled water from discharged toilet flush water, stool will accumulate quickly in tank area (7) and needs to be cleaned regularly, from few days to few weeks, depending on number of people using the toilet and the volume of the water tanks. The stool collected can be used as fertilizer for farmers.

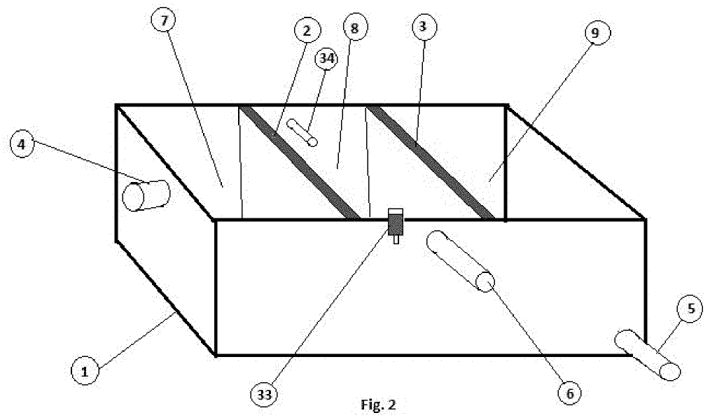

1. A water recycle system with the component number shown in FIG. 1 and FIG. 2 comprising:
a first water tank (1) with a sewage water pipe (11) and an overflow pipe (6) and an outflow pipe (5) and 2 two filtration layers (2) (3) or multiple filtration layers and pipes (34) for chemical material (33);
a water level controller switch (12) and a water level scale (28) and a water level indicator (27) in the first water tank;
a pump (14) powered by electricity;
a second tank (17) with a water inflow pipe (15) and a water overflow pipe (19) and a water outflow pipe (32) and a supplement water pipe (35) with a water valve (36);
a water level controller switch (18) and a water level scale (27) and a water level indicator (28) in the second water tank;
characterized in that the sewage water (11) to be reused for flushing toilet after filtration and purification is pumped into the second water tank (17) by the electricity powered pump (14).

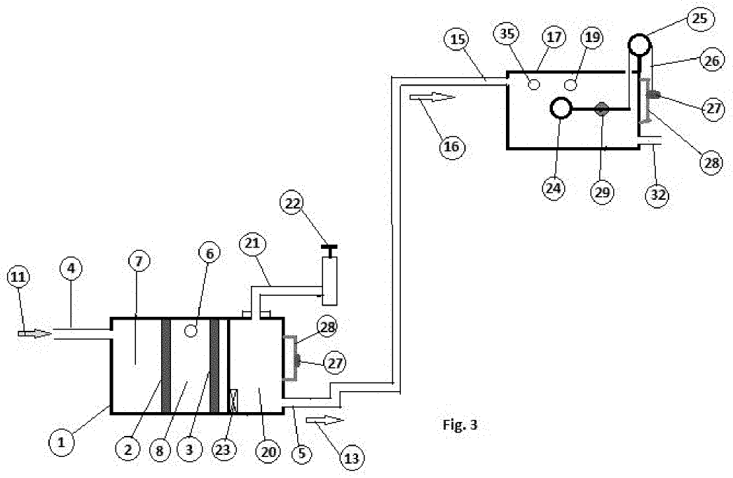

2. A water recycle system with the component number shown in FIG. 3 and FIG. 4 comprising:
a first water tank (1) with a sewage water pipe (11) and an overflow pipe (6) and an outflow pipe (5) and 2 filtration layers (2) (3) or multiple filtration layers and pipes (34) for chemical material (33);
a water level controller switch (12) and a water level scale (28) and a water level indicator (27);
a manual air pump operated by hands (22) or operated by foot (31);
a second water tank (17) with a water inflow pipe (15) and a water overflow pipe (19) and a water outflow pipe (32) and a supplement water pipe (35) with a water valve (36);
a water level controller switch (18) and a water level scale (27) and a water level indicator (28) in the second water tank;
a third sealed tank (20) with a cover (30) and an air inflow pipe (21) and one-way water valves (23);
characterized in that the sewage water (11) to be reused for flushing toilet after filtration and purification is pushed to the second water tank (17) by the manual air pump operated by hands (22) or foot (31) without electricity power supply.

3. A water recycle system as claimed in 1 characterized in that the water recycle system can be installed in all type of building that has toilets and water supply pipe system.

4. A water recycle system as claimed in 2 characterized in that the water recycle system can be installed to movable restrooms and/or restrooms without water supply pipes with the initial water filling in the water tank.
